(19) United States
(12) Patent Application Publication
(10) Pub. No.: US 2026/0368683 A1
(43) Pub. Date: Nov. 19, 2026

(54) ANALYZING AND VISUALIZING BUSINESS-RELATED ENTITIES

(71) Applicant: Primer Labs, Inc., San Francisco, CA (US)

(72) Inventors: Tom MERTENS, Kalmthout (BE); Juan VASQUEZ, Bayside, CA (US)

(21) Appl. No.: 19/575,622

(22) Filed: Mar. 23, 2026

Related U.S. Application Data
(60) Provisional application No. 63/807,313, filed on May 16, 2025.

(51) Int. Cl. G06Q 10/067

(52) U.S. Cl. CPC G06Q 10/067

(57) ABSTRACT

The present invention sets forth techniques for analyzing and visualizing relationships between entities, such as business-related entities. The techniques include calculating vector space positions and importance values for each of multiple entities based on attributes associated with the entities. Based on the vector space positions, the techniques calculate and store pairwise similarity values between all possible entity pairings. The techniques also generate leaf nodes associated with the entities and calculate size values for the leaf nodes based on the associated entities' importance values. The techniques iteratively cluster leaf nodes into internal nodes and cluster internal nodes with leaf and/or internal nodes to generate additional internal nodes before clustering all nodes together into a root node. A size associated with a cluster is equal to the sum of the sizes of the individual nodes comprising the cluster. The techniques may render the resulting hierarchical node representation for display to a user.

### CROSS-REFERENCE TO RELATED APPLICATIONS

This application claims priority benefit to the U.S. provisional application titled “ANALYZING AND VISUALIZING BUSINESS-RELATED ENTITIES,” filed on May 16, 2025, and having Ser. No. 63/807,313. The subject matter of this related application is hereby incorporated herein by reference.

### BACKGROUND

### Field of the Various Embodiments

Embodiments of the present disclosure relate generally to the construction and visualization of hierarchical entity relationships and, more specifically, to techniques for analyzing and visualizing relationships between various business entities, including all aspects of the related hardware, software, graphical user interfaces, and algorithms associated with implementing the contemplated systems, techniques, functions, and operations set forth herein.

### Description of the Related Art

The accurate representation and visualization of hierarchical relationships between business-related entities may enhance the interpretation of the entities, as well as associated data, signals, or other characteristics associated with the entities. For example, associated characteristics may include company headcount, industry, funding stage, or market capitalization. Associated characteristics may also include topical information associated with an entity, including statistics related to advertising campaigns, recent news items, and/or press releases.

Existing techniques for representing and visualizing hierarchical relationships may recursively group or cluster entities and produce a classical tree structure. In these tree structures, the leaf nodes may represent the entities, while the internal nodes may recursively represent clusters of entities and clusters of clusters, ultimately culminating in a root node that includes all of the represented entities.

One drawback of the existing techniques is that the techniques may produce a hierarchical structure that ignores similarities and differences in entity characteristics, such as size, when clustering or otherwise grouping entities. Such techniques may, for example, present two entities at the same level in a hierarchical arrangement, even though the size of one entity, e.g., its headcount or market capitalization, may be several orders of magnitude smaller or larger than the other entity. Further, existing visualization techniques that naively scale one or more visually adjacent display primitives based on the magnitude of the nodes' sizes or other characteristics may produce unintelligible visualizations due to the vast differences in relative entity sizes.

Existing clustering techniques may account for relative differences in size or other entity characteristics when forming clusters, but may cluster entities in an arbitrary order, such that two large, similarly sized entities may be grouped together into a cluster that is too large to be subsequently grouped with other, smaller clusters. These techniques may lead to multiple clusters exhibiting a wide range of sizes that are difficult to present in an interpretable visualization.

As the foregoing illustrates, what is needed in the art are more effective techniques for analyzing and visualizing business-related entities.

### SUMMARY

In some aspects, the techniques described herein relate to techniques for analyzing business-related entities. The techniques include generating an entity representation associated with each of a plurality of entities wherein, for a pair of entities in the plurality of entities, a similarity between the pair is determined based on respective entity representations for the pair. The techniques also include generating, for each entity representation, an importance metric based on the entity representation and generating a plurality of leaf nodes included in a hierarchical tree representation based on the entity representations associated with the plurality of entities, wherein a size associated with a leaf node representing a given entity corresponds to the importance metric associated with the entity. The techniques further include generating two or more partitions of leaf nodes based on the sizes associated with each of the leaf nodes.

One technical advantage of the disclosed techniques relative to the prior art is that the disclosed techniques process nodes on a per-partition basis by increasing size. These techniques ensure that smaller nodes are always clustered together before larger nodes, preserving the possibility that a cluster of smaller nodes may subsequently be merged with a larger node or cluster of nodes having a similar size as the cluster of smaller nodes. During visualization, sibling nodes (either leaf nodes, or internal nodes representing clusters of leaf nodes or clusters of clusters) occupying the same level of a tree map or similar hierarchical representation will always exhibit similar sizes, improving the readability and interpretability of the hierarchical representation. These technical advantages provide one or more improvements over prior art approaches.

### BRIEF DESCRIPTION OF THE DRAWINGS

So that the manner in which the above recited features of the various embodiments may be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present invention.

FIG. 2 is a more detailed illustration of the visualization engine of FIG. 1, according to some embodiments.

FIG. 3A illustrates multiple nodes, each representing an entity including an associated size, according to some embodiments.

FIG. 3B illustrates a result of applying an arbitrarily ordered clustering algorithm to the multiple nodes of FIG. 3A, according to some embodiments.

FIG. 3C illustrates a result of applying a size-aware ordered clustering algorithm to the multiple nodes of FIG. 3A, according to some embodiments.

FIG. 4 illustrates a partition-based clustering technique, according to some embodiments.

FIG. 5 illustrates a hierarchical arrangement of internal nodes and leaf nodes, according to some embodiments.

FIG. 6 illustrates Voronoi map depictions of the hierarchical arrangement of the visualize engine of FIGS. 1 and 2 at various levels of detail, according to some embodiments.

FIG. 7A illustrates a sample graphical user interface display of a Voronoi map depiction at a first magnification, according to some embodiments.

FIG. 7B illustrates a sample graphical user interface display of a Voronoi map depiction at a second magnification, according to some embodiments.

FIG. 8 is a flow diagram of method steps for generating one or more partitions including leaf nodes that each represent a different entity, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

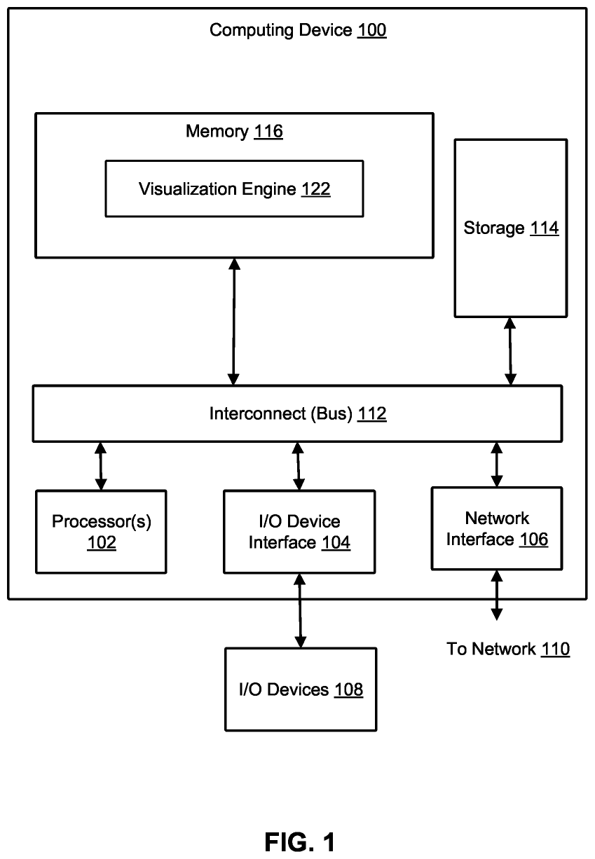

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run visualization engine 122 that resides in a memory 116.

It is noted that the computing device described herein is illustrative and that any other technically feasible configurations fall within the scope of the present disclosure. For example, multiple instances of visualization engine 122 could execute on a set of nodes in a distributed and/or cloud computing system to implement the functionality of computing device 100. In another example, visualization engine 122 could execute on various sets of hardware, types of devices, or environments to adapt visualization engine 122 to different use cases or applications. In a third example, visualization engine 122 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (Wi-Fi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Visualization engine 122 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that may be executed by processor(s) 102 and application data associated with said software programs, including visualization engine 122.

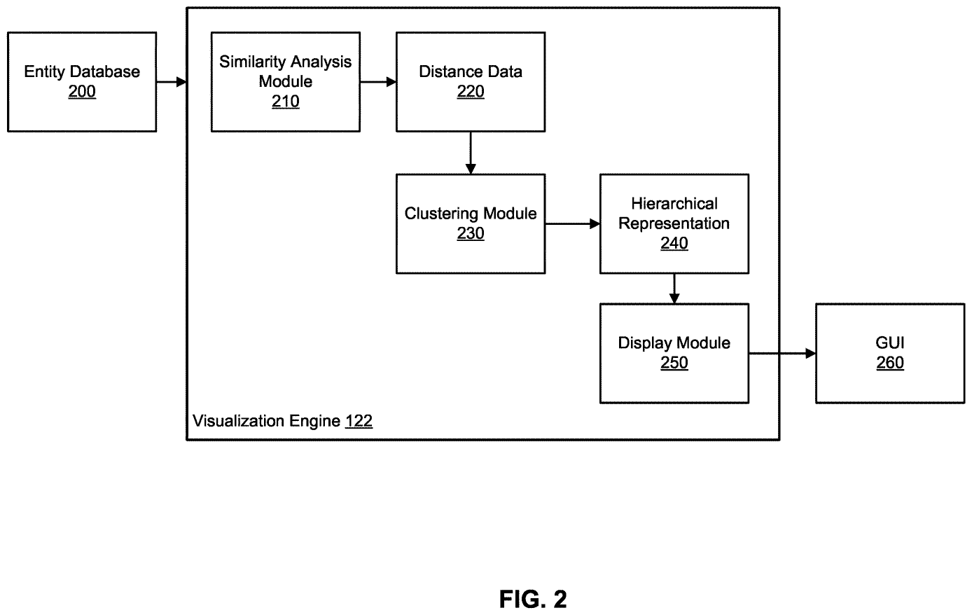

FIG. 2 is a more detailed illustration of visualization engine 122 of FIG. 1, according to some embodiments. In various embodiments, visualization engine 122 may analyze entity database 200 that includes attribute information associated with each of multiple entities included in a collection of entities. Based on the analysis, visualization engine 122 may generate a hierarchical structure representing one or more attribute relationships between the entities. Visualization engine 122 may also generate a visual representation of all or a portion of the hierarchical structure for display on graphical user interface (GUI) 260. Visualization engine 122 includes, without limitation, similarity analysis module 210, distance data 220, clustering module 230, hierarchical representation 240, and display module 250.

In various embodiments, entity database 200 may include multiple entries, where each entry includes a different entity and one or more attributes associated with the entity. In at least one embodiment, an entry included in entity database 200 may include a business-related entity, e.g., a company, an individual, a job title, or a city. The one or more attributes associated with a business-related entity may include data, signals, and/or events associated with the business-related entity. The attributes may include, e.g., company headcount, industry or funding stage. The attributes may also include data that changes frequently, such as conversions with respect to an advertising campaign, recent news items, press releases, and/or business-related statistics. In various embodiments, attributes may include data retrieved and/or received from one or more business data provides via, e.g., the Internet.

In various embodiments, an entity included in entity database 200 may also include an associated importance value. An importance value associated with an entity may be based on a single attribute associated with the entity, e.g., the entity's headcount, gross income, profits, market share, market capitalization, geographical span, or perceived prestige. Alternatively, an entity's importance value may be based on a combination of two or more entity attributes or characteristics.

In at least one embodiment, relative sizes associated with visual representations and/or data structure representations of different entities and/or clusters of entities generated by the disclosed techniques may be based on importance values associated with each of the different entities of clusters of entities. For the purposes of discussion, an entity or cluster's associated importance value may alternatively be referred to as the entity or cluster's size. This terminology is not intended to be limiting, and embodiments are contemplated in which the size of an entity and/or cluster does not represent any physical dimension associated with the entity and/or cluster. Visualization engine 122 may compute the size of an entity sₑ using some function Π based on a set of one or more attributes Θₑ associated with the entity:

sₑ=Π(Θₑ) Equation (1)

When generating and/or displaying a hierarchical representation of the entities included in entity database 200, it may be desirable to arrange entities and/or clusters of entities having similar individual or collective sizes together in the hierarchical representation or visual display. For example, a hierarchical tree representation of multiple entities may include a root node and one or more hierarchical levels each including internal and/or leaf nodes. A root node may represent all of the entities included in entity database 200, a leaf node may represent a single entity, and an internal node may represent a cluster of multiple entities. Constructing the tree representation in such a manner that leaf and/or internal nodes that occupy a same hierarchical level include similar associated sizes may provide an intuitive representation of the relative sizes of the entities. For example, a tree representation may include an internal node that represents a cluster of twenty smaller entities and that occupies the same hierarchical level as a leaf node that represents a single entity having an associated size that is approximately equal to the combined sizes of the twenty smaller entities represented by the internal node. Generating a hierarchical arrangement of nodes representing entities and/or clusters of entities is described in greater detail in the discussions of clustering module 230 and hierarchical representation 240 below.

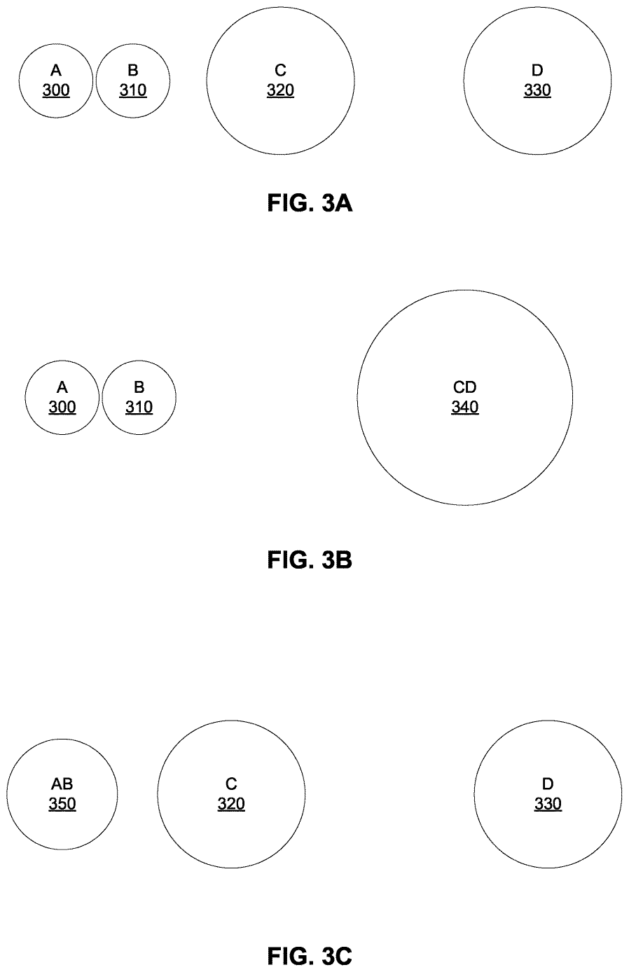

Turning now to FIGS. 3A-3C, FIG. 3A illustrates multiple nodes, each representing an entity including an associated size, according to some embodiments. FIG. 3A depicts node A 300, node B 310, node C 320, and node D 330. As shown, sizes associated with each of node A 300 and node B 310 are approximately equal. Similarly, sizes associated with each of node C 320 and node D 330 are approximately equal.

When generating a hierarchical representation that includes multiple nodes, e.g., a tree representation, it may be desirable to cluster two or more smaller nodes together to form a single, larger node. For example, it may not be feasible to display every entity included in an instance of entity database 200 that contains millions of entries, as the resulting display may be too visually dense or cluttered for a user to interpret. Further, operations that act on a hierarchical representation, such as traversal, searching, pruning, or rearranging, may require an amount of time and/or computing resources that scale as a function of the number of nodes included in the representation. Clustering multiple nodes into a single node may reduce the time or other resources required to process a hierarchical representation.

FIG. 3B illustrates a result of applying an arbitrarily ordered clustering algorithm to the multiple nodes of FIG. 3A, according to some embodiments. In various arbitrarily ordered clustering algorithms, all leaf nodes representing entities may be included in a single pool of nodes, and the algorithms may identify any group of nodes that include similar associated sizes as candidates for clustering. As shown, an arbitrarily ordered clustering algorithm has clustered node C 320 and node D 330 together as cluster CD 340 based on the nodes' similar sizes. If the arbitrarily ordered clustering algorithm were to subsequently combine node A 300 and node B 310, the algorithm may not identify resulting cluster AB (not shown) and cluster CD 340 as candidates for further clustering, as the respective sizes associated with cluster AB and cluster CD 340 may be too dissimilar.

FIG. 3C illustrates a result of applying a size-aware ordered clustering algorithm to the multiple nodes of FIG. 3A, according to some embodiments. Although the arbitrarily ordered clustering algorithm described in the discussion of FIG. 3B above identifies nodes as candidates for clustering based on their respective sizes, a size-aware ordered clustering algorithm not only identifies clustering candidates based on size, but also determines an order for selecting and clustering nodes, where the order is based on the relative sizes of all nodes in the pool of nodes.

As shown, the size-aware ordered clustering algorithm processes smaller nodes before processing larger nodes. As a result, the algorithm initially identifies node A 300 and node B 310 as candidates for clustering and combines the two nodes to generate cluster AB 350. As the algorithm continues to process the remaining nodes and clusters from smallest to largest, the algorithm may subsequently identify cluster AB 350 and either of node C 320 or node D 330 as clustering candidates. The size-aware ordered clustering algorithm may therefore be operable to combine the nodes included in a pool of nodes into a smaller quantity of clusters compared to an arbitrarily ordered clustering algorithm. Further, the resulting nodes and/or clusters may include associated sizes that are more similar to one another compared to those generated by the arbitrarily ordered clustering algorithm. Size-aware ordered clustering algorithms are described in greater detail in the description of clustering module 230 below.

Returning to FIG. 2, similarity analysis module 210 receives a list of entities and attributes associated with each of the entities from entity database 200. Based on the entities and associated attributes, similarity analysis module 210 calculates distance data associated with the entities. Distance data is discussed in greater detail in the description of distance data 220 below.

In various embodiments, similarity analysis module 210 may convert each entity included in entity database 200 into a high-dimensional data point, where proximity between high-dimensional data points associated with two entities may reflect a level of relative similarity between the two entities. Coordinate values included in a high-dimensional data point associated with an entity may be based on all or a predetermined subset of the attributes associated with the entity. For example, similarity analysis module 210 may include a trained machine learning model, such as a neural network, operable to generate one or more embedding vectors based on textual attributes associated with an entity, such as a description of the entity, a description of an industry associated with the entity, and/or one or more city, state, or country names associated with the entity.

In various embodiments, similarity analysis module 210 may perform one or more dimensionality reduction techniques on the high-dimensionality data points associated with the entities. Reducing the dimensionality of the data points may enable more efficient processing of a large number, e.g., millions of entities included in entity database 200. These dimensionality reduction techniques may include, but are not limited to, principal component analysis (PCA), t-distributed stochastic neighbor embedding (t-SNE), and/or uniform manifold approximation and projection (UMAP). A data point (having either a high dimensionality or a reduced dimensionality) associated with an entity may be referred to as the entity's position, and similarity analysis module 210 may calculate a distance between a given pair of entities based on a calculated distance, e.g., a Euclidean distance, between the data points associated with the two entities.

In various embodiments, similarity analysis module 210 may associate each entity with its corresponding position and store a list of entities and corresponding positions as distance data 220, such that visualization engine 122 may subsequently calculate a distance between any two entities when required. Alternatively or additionally, similarity analysis module 210 may compute distances between all possible pairs of entities included in entity database 200 and store the computed values in distance data 220 as a similarity representation. For example, given an instance of entity database 200 that includes a quantity N of entities, similarity analysis module 210 may generate an N×N matrix and populate each cell in the matrix with a distance value calculated between a first entity associated with the cell's row and a second entity associated with the cell's column. Similarity analysis module 210 may generate a similarity representation that includes any data structure suitable for recording pairwise distances between points, including hierarchical and/or sparse representations. Visualization engine 122 transmits distance data 220 to clustering module 230.

In various embodiments, clustering module 230 may generate hierarchical representation 240, where hierarchical representation 240 includes an arrangement of leaf nodes each representing an individual entity and/or internal nodes each representing a cluster generated by merging multiple leaf and/or internal nodes. In various embodiments, a size associated with a leaf node may be based on the size of an entity associated with the leaf node, as discussed above. A size associated with an internal node may be based on a recursive summation of the sizes of all child nodes (leaf or internal) that descend from the internal node. Accordingly, a size associated with an internal node is a summation of sizes associated with all leaf nodes (entities) that descend from the internal node, either directly or as part of another internal node.

### Distance Metric

Clustering module 230 may also calculate a distance metric associated with a pair of nodes that describes a level of similarity between the nodes. While similarity analysis module 210 is operable to calculate a similarity distance between two individual entities as described above, clustering module 230 may calculate a distance metric between any two nodes, where either node may include a leaf node that represents an individual entity or an internal node that represents a clustered set of leaf and/or internal nodes.

A distance metric D(·,·) may describe a level of similarity between two nodes. For example, a distance metric associated with nodes A and B may be expressed as D(A, B). D(A, B) may exhibit a positive and monotonically increasing value as A and B become more dissimilar. Further, a set of entities that descend from an arbitrary node C may be expressed as set V (C). Clustering module 230 may also calculate an intermediate distance measurement [symbol] between nodes A and B:

[symbol]

={d(a,b)|a∈V(A),b∈V(B)}, Equation (2)

where d(a, b) is a suitable distance metric between the positions of entities a and b. Intermediate distance measurement [symbol] represents the set of all possible pairwise similarity distances between each entity a descending from node A and each entity b descending from node B. In various embodiments in which distance data 220 includes positions associated with each entry included in entity database 200 as discussed above, clustering module 230 may calculate d(a, b) based on, e.g., a Euclidean distance between the positions associated with each of entities a and b. In various embodiments in which distance data 220 includes a distance matrix, clustering module 230 may instead retrieve d(a, b) directly from the distance matrix without further calculations.

Clustering module 230 may calculate D(A, B) based on [symbol] and one of multiple distance metrics that are based on agglomerative clustering algorithms, such single linkage, complete linkage, or centroid linkage. A single linkage distance metric D_{single} between nodes A and B may represent a minimum similarity distance included in the set [symbol] of all pairwise similarity distances between entities descending from node A and entities descending from node B:

D_{single}(A,B)=min( [symbol] ) Equation (3)

A complete linkage distance metric D_{complete} between nodes A and B may represent a maximum similarity distance included in the set [symbol] of all pairwise similarity distances between entities descending from node A and entities descending from node B:

D_{complete}(A,B)=max( [symbol] ) Equation (4)

A centroid linkage distance metric D_{centroid} between nodes A and B may represent a similarity distance between two nodes based on the distance between the geometric centers of the two nodes, where a geometric center of a node represents an average of all the position values associated with entities descending from the node:

$$Equation ( 5 )$$

$${D}_{c e n t r o i d} ( A , B ) = {‖ \frac{1}{\vert ⋁ ( A ) \vert} {\sum }_{a ∈ ⋁ ( A )} ( a ) - \frac{1}{\vert ⋁ ( B ) \vert} {\sum }_{b ∈ ⋁ ( B )} ( b ) ‖}^{2} ,$$

where |S| denotes the number of elements in a set S.

In various embodiments where clustering module 230 calculates entity similarity distances based on their associated positions rather than retrieving similarity distances from a distance matrix, clustering module 230 may also associate a position with an internal node and utilize the internal node's position during distance metric calculations. In these embodiments, D (·,·) may include a function that directly computes a similarity distance between node positions associated with, e.g., nodes A and B, without requiring distance calculations associated with individual entities included in the sets V (A) and V(B). An internal node's position may be determined by calculating a centroid of the positions associated with the internal node's children. This technique may yield distance metric values that are similar to, although not identical to the D_{centroid}(A, B) distance metric value discussed above. This technique may also reduce an implementation complexity associated with the distance metric value calculation, while also improving computational speed.

### Size-Aware Hierarchical Clustering

In various embodiments, clustering module 230 may generate multiple leaf nodes, where each leaf node is associated with an individual entity included in entity database 200. Clustering module 230 may arrange the leaf nodes in order from smallest to largest and place each leaf node into one of multiple disjoint partitions, based on a size associated with the leaf node. Clustering module 230 may begin at a partition that includes the smallest leaf node and cluster multiple leaf nodes that are included in the partition together to form one or more internal nodes, where a size associated with an internal node is equal to a summation of the sizes associated with the leaf nodes that were merged to form the internal node. For each newly created internal node, clustering module 230 may identify an appropriate destination partition in which to place the internal node, based on the size associated with the internal node.

In various embodiments, one or more clustering algorithms included in clustering module 230 may predetermine a quantity of fixed- or variable-width partitions and assign each node to one of the existing partitions. Additional clustering algorithms included in clustering module 230 may determine partition sizes at runtime based on sizes associated with the individual entities. Each of the various clustering algorithms will be described in detail below.

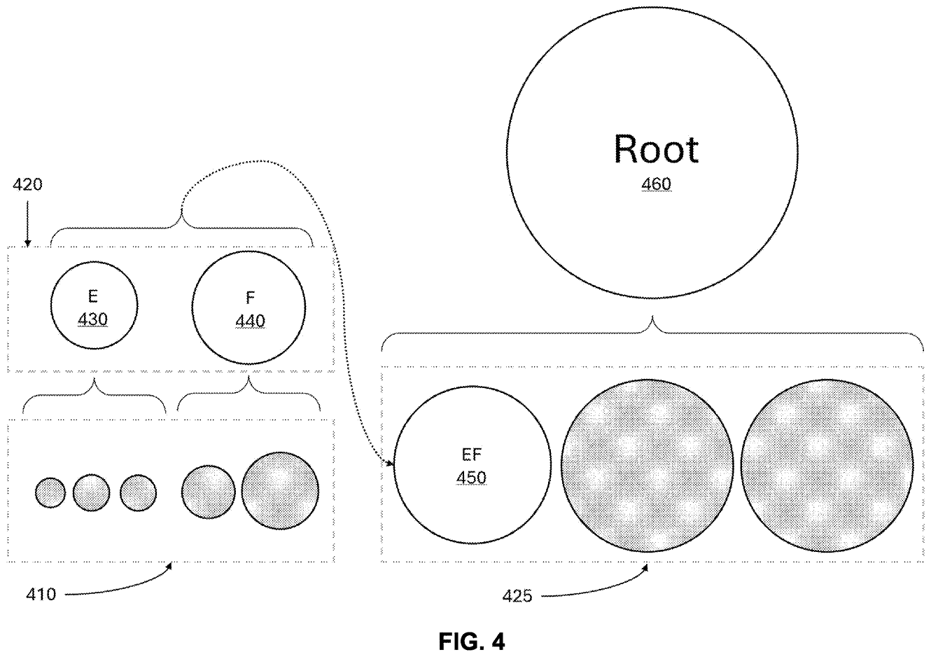

Turning now to FIG. 4, FIG. 4 illustrates a partition-based clustering technique, according to some embodiments. The clustering operations depicted in FIG. 4 are not specific to any particular clustering algorithm. Rather, FIG. 4 is intended to introduce partition-based clustering techniques and their treatment of leaf nodes and internal nodes.

As shown, each of partition 410, partition 420 and partition 425 includes multiple nodes. Prior to the application of the clustering algorithm, node EF 450 does not yet exist and is not included in partition 425. Similarly, prior to the application of the clustering algorithm, nodes E 430 and F 440 do not exist and partition 420 is empty. In the depicted example, clustering module 230 creates partition 410, partition 420 and partition 425. Each of partition 410, partition 420 and partition 425 includes an associated node size range, where partition 410 is associated with smaller nodes than the nodes associated with partition 420, and partition 420 is associated with smaller nodes than the nodes associated with partition 425. Clustering module 230 arranges the leaf nodes representing individual entities in order from smallest to largest, based on the sizes associated with each leaf node. Leaf nodes are depicted in FIG. 4 as grey circles. After clustering module 230 creates the partitions and orders the leaf nodes, clustering module 230 places each leaf node inside a partition having an associated node size range that encompasses the size associated with the leaf node. As shown, clustering module 230 placed five leaf nodes in partition 410, zero leaf nodes in partition 420, and two leaf nodes in partition 425.

Within each partition, clustering module 230 applies a non-hierarchical clustering technique to the leaf nodes included in the partition. Because all of the nodes in a particular partition are associated with sizes that fall within the partition's node size range, all the nodes within a particular partition are guaranteed to have similar associated sizes. The non-hierarchical clustering technique may calculate similarity distance metrics between pairs of leaf nodes in a partition and identify one or more groups of leaf nodes, where all the leaf nodes within an identified group represent similar entities. As shown, clustering module 230 has identified the three leftmost leaf nodes included in partition 410 as a set and merged those leaf nodes to form internal node E 430. In a similar fashion, clustering module 230 has identified the two rightmost leaf nodes included in partition 410 as a set and merged those leaf nodes to form internal node F 440. The size associated with internal node E 430 is equal to the sum of the three smaller leaf nodes from which it was formed, and the size associated with internal node F440 is equal to the sum of the two larger leaf nodes from which it was formed. Clustering module 230 puts both internal node E 430 and internal node F 440 in partition 420, because each of the internal nodes' associated sizes falls above the node size range associated with partition 410 and within the node size range of partition 420.

Although the operation of the clustering algorithm as depicted resulted in one cluster formed from the smallest leaf nodes in partition 410 and a second cluster formed from the largest leaf nodes in partition 410, this outcome is not a necessary consequence of the clustering algorithm. Because partition 410 includes an associated limited range of node sizes, any node included in partition 410 is eligible to be merged with any other node(s) in the same partition, based on the pairwise similarity metrics associated with the nodes.

In a subsequent operation, the clustering algorithm merges internal node E 430 with internal node F 440 to form internal node EF 450. The size of newly formed internal node EF 450 is equal to the sum of the sizes associated with internal node E 430 and internal node F 440. The size of internal node EF 450 is larger than the upper bound of the node size range associated with partition 420. Clustering module 230 then identifies partition 425 as including an associated node size range that encompasses the size of internal node EF 450 and places internal node EF 450 in partition 425.

As there are no nodes remaining in partition 420, the clustering algorithm of clustering module 230 selects a next partition to process. Because partition 425 is associated with a node size range that includes the smallest node sizes that are greater than the upper bound of the node size range associated with partition 420, the clustering algorithm proceeds to partition 425. The clustering algorithm identifies internal node EF 450 and the two leaf nodes included in partition 425 as a set and merges the three nodes into root node 460. As there are no non-empty partitions remaining, the clustering algorithm terminates. After the clustering algorithm terminates, the size associated with root node 460 is equal to the sum of the sizes associated with all the leaf nodes depicted in FIG. 4.

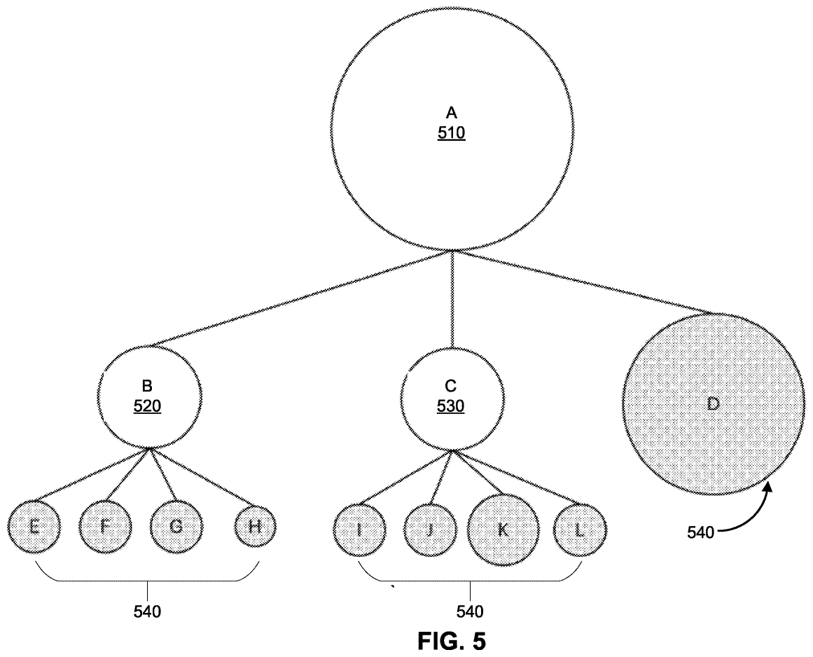

As the clustering algorithm processes partitions and merges nodes into larger nodes and eventually merges all remaining nodes into a root node, clustering module 230 may generate hierarchical representation 240 that preserves the hierarchical arrangement of all the nodes associated with entities included in entity database 200. For example, hierarchical representation 240 preserves the relationship that root node 460 is comprised of internal node EF 450 and the two leaf nodes that were placed in partition 425. In a similar manner, hierarchical representation 240 records the relationships that internal node EF 450 is comprised of internal node E 430 and internal node F 440 that were placed in partition 420, and that internal node E 430 is comprised of three specific leaf nodes that were placed in partition 410. Hierarchical representation 240 is discussed in greater detail in the description of FIG. 5 below.

### Clustering in Partitions Having Disjoint Node Size Ranges

In various embodiments, clustering algorithms included in clustering module 230 may operate on multiple partitions, where node size ranges associated with each of the multiple partitions are disjoint from one another. Clustering module 230 may represent the multiple partitions as an ordered one-dimensional (1D) list of partitions, such that partitions near one end of the list, i.e., smaller partitions, are associated with node size values that are relatively smaller than partitions near the other end of the list, i.e., larger partitions.

Algorithm A1 below describes a general technique for clustering a set of leaf nodes, where each leaf node represents a different entity and includes an associated size value. In various embodiments, clustering module 230 may pre-initialize a set of partitions, and assign each partition a predetermined node size range. Alternate techniques for determining a node size range associated with each of multiple partitions are described further below in the discussion of Algorithm A1b.

### Algorithm A1

1. Subdivide the leaf nodes into a list of sized-based partitions, such that each partition is guaranteed to contain nodes with similar sizes. Consequently, each partition P includes an associated size range r_{P}. The list is ordered, and clustering module 230 constructs the partitions such that their ranges are disjoint. For example, given two partitions P and Q, then P comes before Q if r_{P} is located before r_{Q}.
2. For each partition P in the ordered list of partitions, proceeding from smaller to larger partitions:
   a. Apply a non-hierarchical clustering technique to the nodes in P based on the distance metric D(·,·). The result of the clustering technique includes a set of clusters, where each cluster is associated with a set of nodes.
   b. From each cluster, generate a new internal node. For each of the internal nodes, calculate a size associated with the internal node, where the associated size is equal to the sum of the sizes associated with the nodes inside the corresponding cluster.
   c. For each of these new nodes C having size s_{C}, add C to a partition Q where s_{C}∈r_{Q}. If s_{C} falls beyond the range of the last, i.e., largest partition, clustering module 230 may generate a new largest partition and place C in the newly generated largest partition.

Step A1.2.c above ensures that a new node C will be positioned for clustering among similarly sized nodes. Consider partitions P and Q in step A1.2.c. Partition Q will never represent a partition that is smaller than partition P, because clustered nodes are always larger than any of their children. In some instances where the size of the new node C falls within the node size range of partition P, partitions P and Q may represent the same partition. In various embodiments, clustering module 230 may define the partition ranges such that s_{C}∉r_{P}. In these embodiments, clustering module 230 must therefore place a new node C into a different, larger partition than partition P where clustering module 230 initially created the new node C.

For some collections of entities included in entity database 200, clustering module 230 may encounter partitions Pᵢ with |Pᵢ|<2 during the loop in step 2 of algorithm A1, where |Pᵢ| represents a quantity of nodes included in partition Pᵢ. Specifically, one or more partitions may each include fewer than two nodes in instances where node sizes associated with the entities included in entity database 200 vary over a wide range, causing a sparse distribution of nodes across the partitions. It is not possible to generate a cluster in a partition that includes no nodes or that includes only a single node. In various embodiments, clustering module 230 may address these situations by skipping partitions and/or moving any node included in a singleton partition, i.e., a partition P for which |P|=1, into a next larger partition that already includes at least one node.

### Constructing Partitions Having Disjoint Node Size Ranges

As discussed above, in various embodiments in which clustering module 230 includes Algorithm A1, the algorithm may commence with a pre-initialized set of partitions, generate internal nodes by merging a set of nodes included in a partition, and then place the newly generated internal node into a partition that includes a corresponding node size range. Some of these partitions may be empty, as demonstrated by the example in FIG. 4 in which partition 420 is only populated after the partition 410 has been clustered. Various embodiments of the present disclosure may additionally or alternatively include one or more variants of Algorithm A1 in which clustering module 230 generates partitions and assigns corresponding partition node size ranges at runtime.

In various embodiments, clustering module 230 may generate partitions when initially placing leaf nodes by calculating an integer partition index i based on a size associated with a current node to be placed. For example, given a node A with size s_{A}, clustering module 230 may compute an integer index i=|ƒ(s_{A})| with some function ƒ that linearly or nonlinearly transforms the 1D space of node sizes into a discrete space of partitions. For a partition Pᵢ that corresponds to index i, partition Pᵢ may include a corresponding node size range expressed as a half-open interval

$${r}_{i} = [ {s}_{i}^{l} , {s}_{i}^{u} [ , where {s}_{i}^{l}$$

represents a lower, or smallest node size to be associated with partition Pᵢ and

$${s}_{i}^{u}$$

represents an upper, or largest node size to be associated with partition Pᵢ.

For example, a linear function ƒ will result in partitions having a fixed width. If clustering module 230 defines a linear function

$$f = ⌊ \frac{{s}_{A}}{w} ⌋ ,$$

where w is the desired fixed partition width, then a node A that includes a corresponding size s_{A} would be associated with a partition index

$$i = ⌊ \frac{{s}_{A}}{w} ⌋ .$$

Alternatively, clustering module 230 may implement varying partition widths using a logarithmic function for ƒ. For example, clustering module 230 may calculate an integer partition index i=└logₚ(s_{A})┘. In these embodiments, clustering module 230 may apply a scaling and/or offset factor to each of the node sizes to ensure sizes s_{A}≥1 such that i≥0. By defining i to equal └logₚ(s_{A})┘, the maximum ratio of node sizes associated with a single partition is always less than p:

$$∀ A , B ∈ {P}_{i} with {s}_{A} < {s}_{B} : \frac{{s}_{B}}{{s}_{A}} < ρ \qquad Equation ( 6 )$$

Both the w and p parameters may provide intuitive control over the similarity of node sizes within a partition. Various embodiments may include different functions ƒ that include one or more parameters to enable similar control over partition node size ranges. An Algorithm A1b includes a variant of Algorithm A1 that implements the above techniques for assigning node size ranges to partitions.

### Algorithm A1b

1. Assign each node A with size s_{A} to partition Pᵢ with i=└ƒ(s_{A})┘
2. For every partition Pᵢ ordered by i:
   a. Apply non-hierarchical clustering to the nodes in P based on the distance metric D(·,·). The result of the clustering technique includes a set of clusters, where each cluster is associated with a set of nodes.
   b. From each cluster, generate a new internal node. For each of the internal nodes, calculate a size associated with the internal node, where the associated size is equal to the sum of the sizes associated with the nodes inside the corresponding cluster.
   c. For each of these new nodes C having size s_{C}, add C to Pⱼ with j=└ƒ(s_{C})┘.

In various embodiments, clustering module 230 may efficiently represent the partitions using a map data structure that maps an index i to an array containing the elements in the i-th partition. Similarly, clustering module 230 may index a partition array on i, where the partition array contains arrays of elements. In this embodiment, some arrays of elements may be empty.

### Clustering Using a Single Ephemeral Partition

In various embodiments, clustering algorithms included in clustering module 230 may operate on an ordered list L of nodes, where the nodes are ordered from smallest to largest based on the node sizes associated with each of the nodes. In various embodiments, an Algorithm A2 may generate a single partition based on a range criterion, where the partition includes a quantity of similarly sized nodes removed from list L. Clustering module 230 may then cluster the removed nodes to generate new internal nodes and insert the newly generated internal nodes into list L while preserving the smallest-to-largest ordering within list L. Various techniques for determining a range criterion are discussed below.

### Algorithm A2

1. For a collection of leaf nodes each representing a different entity, place all the leaf nodes in a list L in ascending order based on node sizes associated with the leaf nodes.
2. While there are unprocessed nodes remaining in list L:
   a. Construct a partition P that includes nodes in L using a range criterion, such that P contains nodes that are similar in size.
   b. Remove all the nodes that are included in P from L.
   c. Apply a non-hierarchical clustering technique to the nodes in P based on the distance metric D(·,·). The result of the clustering technique includes a set of clusters, where each cluster is associated with a set of nodes.
   d. From each cluster, generate a new internal node. For each of the newly generated internal nodes, calculate a size associated with the internal node, where the associated size is equal to the sum of the sizes associated with the nodes inside the corresponding cluster.
   e. For each of these new nodes C, add C to L based on size s_{C} associated with nodes C, such that the smallest-to-largest ordering in L is maintained.

In various embodiments, clustering module 230 may implement A2 by representing L as an array, where an index separates the nodes that have been removed by step A2.2.b from the remainder of L. Further, clustering module 230 may maintain the ordering in L by first sorting only the new nodes C in step A2.2.e, and then combining the new nodes C with the unprocessed portion of L using, e.g., a merge sort. In other embodiments, clustering module 230 may represent L as a tree-based data structure to efficiently preserve ordering as new nodes are added to L.

### Defining a Range Criterion for Algorithm A2

As discussed above, in embodiments in which clustering module 230 includes a clustering algorithm such as Algorithm A2, clustering module 230 may construct a single ephemeral partition on-the-fly, where the partition includes a quantity of nodes removed from list L for processing. In these embodiments, clustering module 230 may determine the nodes to remove from list L based on a range criterion. The range criterion expresses a range rₛ of node sizes as a half-open interval rₛ=[s, ƒ(s)[, where s represents a base size, i.e., a lower bound, associated with the partition, and ƒ represents a function having the characteristic that ∀x>0:ƒ(x)>x. For example, a function ƒ(x)=px directs clustering module 230 to generate a partition that includes a logarithmic-style partition width. Specifically, larger values of base size s will generate larger node size ranges rₛ. Similar to the logarithmically sized partitions discussed above in reference to Algorithm A1b, a range criterion defined by ƒ(x)=px shares a similar property in that the maximum ratio of node sizes encompassed by the resulting node size range rₛ will always be less than or equal to p. An Algorithm A2b includes a variant of Algorithm A2 that implements the above range criterion.

### Algorithm A2b

1. For a collection of leaf nodes each representing a different entity, place all the leaf nodes in a list L in ascending order based on node sizes associated with the leaf nodes.
2. While there are unprocessed nodes remaining in list L:
   a. Construct a partition P using the half open range r_{P}=[L₁, ƒ(L₁)[where L₁ is the first element in L
   b. Remove all the nodes that are included in P from L.
   c. Apply a non-hierarchical clustering technique to the nodes in P based on the distance metric D(·,·). The result of the clustering technique includes a set of clusters, where each cluster is associated with a set of nodes.
   d. From each cluster, generate a new internal node. For each of the newly generated internal nodes, calculate a size associated with the internal node, where the associated size is equal to the sum of the sizes associated with the nodes inside the corresponding cluster.
   e. For each of these new nodes C, add C to L based on size s_{C} associated with nodes C, such that the smallest-to-largest ordering in L is maintained.

Algorithm A2b differs from Algorithm A2 only in step 2.a, where Algorithm A2b specifies that clustering module 230 calculates the node size range r_{P} associated with partition P based on the node size of the first, i.e., smallest node in list L, represented by L₁. Specifically, the lower bound of r_{P} is equal to a node size associated with L₁, and the upper bound of r_{P} is equal to ƒ(L₁), where function ƒ is chosen such that ƒ(L₁) will always be greater than L₁.

### Non-Hierarchical Clustering Considerations

All of clustering module 230 Algorithms A1, A1b, A2, and A2b discussed above perform non-hierarchical clustering on multiple nodes included in a partition to generate clusters from which clustering module 230 subsequently generates internal nodes. Various embodiments may favor non-hierarchical clustering methods that target a particular cluster size M, such that internal nodes in the tree always have approximately, or sometimes at least, M children. The cluster size M may also be referred to as the branching factor. An implementation of clustering module 230 may include a particular branching factor chosen to meet certain aesthetic needs, as it influences the appearance of hierarchical representation 240. Additionally or alternatively, an implementation of clustering module 230 may include a particular branching factor chosen to meet certain computational needs, as some values of M may be more amenable for efficient implementations when |P| is large.

One class of existing clustering methods targets a fixed total number of clusters K. Setting K to

$$⌊ \frac{\vert P \vert}{M} ⌋$$

may typically result in an approximate branching factor of M. However, these methods are prone to producing singleton clusters, which results in undesirable nodes that include only a single child. Existing clustering techniques that automatically determine a number of clusters, such as DBSCAN, may exhibit the same singleton cluster problem, but these existing techniques may also provide no means to target a particular branching factor M.

In various embodiments, clustering module 230 may include one or more techniques in which non-hierarchical clustering algorithms may be used to achieve a given branching factor M, which avoids the creation of singleton clusters. For example, when M=2, a clustering algorithm may greedily find all pairs of closest nodes, where the algorithm identifies a closest pair of nodes based on the similarity distance between the nodes as discussed herein. For each node, the algorithm finds its closest neighbor, and clusters them if the closest neighbor is not already part of a cluster. The algorithm repeats this process until all nodes have been included in one of multiple clusters. This algorithm may be implemented efficiently using a spatial data structure such as a kd-tree, which exhibits log-linear time complexity. Variants of this technique may perturb the matches stochastically to iteratively obtain a more optimal solution. An optimal node pairing in terms of total sum of distances may be computed using Edmonds' Blossom algorithm and equivalents thereof, albeit with much worse, but still polynomial, time complexity. Whether greedy or optimal, these methods must be adapted to produce one cluster with 3 points in an instance where |P| is odd.

The above greedy technique may be extended to any branching factor M by considering the first M−1 closest neighbors. The technique assumes that |P| is a multiple of M, so the method also must be adapted to deviate from M for one or a few clusters in instances where this assumption does not hold true.

The techniques for M=2 may easily be extended to any value of M that is equal to a power of two by applying the technique multiple times on the result of the previous clustering. For instance, applying a technique twice leads to cluster sizes 4≤M≤6 (accounting for odd counts of |P|).

A hierarchy created by a technique that targets branching factor M=2 may be post-processed into higher branching factors by iteratively updating the hierarchy. In each iteration, the technique looks at each node, its children and its grandchildren, and connects the grandchildren directly to the node while removing the in-between children if the desired branching factor is not met for the node.

### Further Embodiments

In various embodiments, particular values of node size ratio p and branching factor M may produce desirable effects in clustering algorithms included in clustering module 230. For example, consider a value of ρ≤2 and a cluster size of M≥2. Nodes always have sizes equal to the sum of the sizes associated with the clustered nodes from which they were created. For the logarithmic partitions in Algorithm A1b, this relationship leads to the following necessary relationship:

∀A,B∈Pᵢand ρ≤2:[log_{ρ}(s_{A}+s_{B})|>i Equation (7)

A similar relationship exists for algorithm A2b:

$${∀}_{{s}_{A} , {s}_{B}} ∈ {r}_{P} = [ {s}_{P}^{l} , ρ {s}_{p}^{l} [ and ρ \leq 2 : {s}_{A} + {s}_{B} \geq ρ {s}_{p}^{l} \qquad Equation ( 8 )$$

Consequently, for both Algorithms A1b and A2b, the following must hold true: any internal node (cluster) formed inside the current partition will always be moved into a partition that represents a larger size. In other words, for any two nodes included in a partition P, a cluster formed by combining those two nodes will necessarily have an associated node size that is larger than an upper bound node size associated with partition P, meaning that the cluster must be moved into a partition that is associated with larger node sizes. Further, for any clustering method that guarantees a minimum number of nodes M inside a cluster, Equations (7) and (8) hold for any ρ≤M. Consequently, clusters should never be added to the current partition P, justifying step 2.c of Algorithms A1 and A1b, and step 2.c of Algorithms A2 and A2b.

It may be desirable to implement embodiments that employ clustering methods that guarantee a minimum cluster count M, implement Algorithm A1b with a log_{ρ}-based partition definition or implement A2b with ƒ(x)=ρx, and set ρ≤M. Instances where one or more of these conditions are not met may require modifications to clustering algorithms included in clustering module 230 to ensure that the clustering algorithms ignore instances where newly formed nodes are not large enough to be placed into in a following partition, and force the newly formed nodes into the following partition in spite of potential node size differences between the newly formed node and already existing nodes in the following partition. Alternatively, a designer may modify clustering algorithms to add such nodes to the current partition, similar to existing agglomerative clustering methods.

After clustering module 230 finishes clustering leaf nodes representing the entities included in entity database 200, clustering module 230 generates hierarchical representation 240. Hierarchical representation 240 may record all the hierarchical relationships established during the operation of clustering module 230, such that hierarchical representation 240 may specify hierarchy levels associated with each leaf node and internal node in the representation, as well as specifying which nodes (leaf or internal) were clustered together to form larger internal nodes. Because the clustering algorithm(s) included in clustering module 230 sort the leaf nodes by size before clustering nodes based on attribute similarities between the nodes, hierarchical representation 240 may include multiple hierarchical levels within the representation, where all the nodes located at the same hierarchical level include similar associated node sizes. Hierarchical representation 240 may also include internal nodes formed from clusters of similar entities.

Turning now to FIG. 5, FIG. 5 illustrates a hierarchical arrangement of internal nodes and leaf nodes, according to some embodiments. In various embodiments, FIG. 5 may represent one possible visual depiction of the contents of hierarchical representation 240.

As shown, the arrangement of FIG. 5 includes nine leaf nodes 540 represented by shaded circles, internal nodes B 520 and C 530 represented by unshaded circles, and root node A 510 represented by an unshaded circle. Four instances E, F, G, and H of leaf nodes 540 have been clustered together to create internal node B 520. Similarly, four additional instances of leaf nodes 540 have been clustered together to create internal node C 530. Finally, internal nodes B 520 and C 530 have been clustered together with instance D of leaf nodes 540 to create root node A 510. Although not shown to scale in FIG. 5, node sizes associated with the root node and each of the internal nodes are equal to a recursive sum of all nodes that descend from the root or internal node, respectively. Further, clustering module 230 has clustered the leaf nodes in such a manner that the three nodes occupying the middle level of the depicted hierarchical representation include associated node sizes that are similar enough for the three nodes to have been clustered together.

### GUI Data Structures and Example Presentations

Returning to FIG. 2, display module 250 may render the information stored in hierarchical representation 240 into a format suitable for display on, e.g., a computer display that includes a graphical user interface (GUI). In various embodiments, display module 250 may render hierarchical representation 240 as a tree-like presentation, similar to the presentation depicted in FIG. 5. Display module 250 may also render hierarchical representation 240 into one or more different presentations, such as a Voronoi treemap.

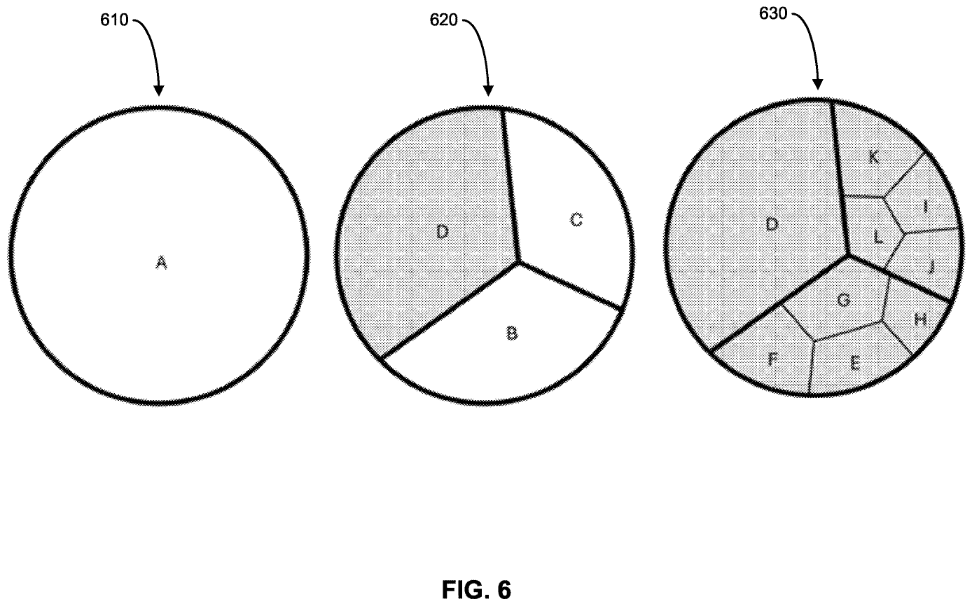

Turning now to FIG. 6, FIG. 6 illustrates Voronoi map depictions of hierarchical representation 240 of visualization engine 122 at various levels of detail, according to some embodiments, taking as input the example hierarchy depicted in FIG. 5. From left to right, treemap 610 displays only the first level, i.e., the root node A 510. Treemap 620 displays the three largest children B 520, C 530 and D of the root node A 510. Treemap 630 displays the highest level of detail, revealing leaf nodes 540 that comprise the larger internal nodes. Polygons that correspond to a leaf node are shaded. Voronoi treemaps are constructed such that the polygon sizes are proportional to the corresponding node sizes in hierarchical representation 240. The initial domain of the Voronoi treemap may be any arbitrary convex domain. As shown, a circular polygon was chosen as the initial domain.

In various embodiments, a Voronoi treemap implementation computes a convex polygonal primitive for each node. In general, any method may be used to render hierarchical representation 240 if two conditions are met. The method must compute a graphical primitive with bounded support, e.g., polygons, rectangles, circles, or ellipses. The method must also determine a size associated with each primitive based on a corresponding size of a node that the primitive represents.

Various embodiments of the present disclosure may implement efficient rendering of such primitive hierarchies by implementing one or more culling techniques and/or selecting an appropriate level of detail for display. A view may be defined as a rectangular region of the treemap where the aspect ratio of this rectangle corresponds to an aspect ratio of a user's screen or the window in which the map is being displayed. As the user zooms in, the view shrinks relative to the entirety of the map. For the sake of efficiency, display module 250 may remove or “cull” primitives that do not overlap with the view and therefore do not need to be rendered or displayed. Further, displaying even just the primitives that overlap with the user's view may result in slow frame rates and a cluttered appearance if the user attempts to view all the hierarchy levels of hierarchical representation 240. In various embodiments, it may be desirable to limit the range of displayed hierarchy levels, both to reduce the time required to render the selected primitives and to avoid visual clutter. In various embodiments, display module 250 may implement a recursive rendering algorithm that starts at the root of hierarchical representation 240 and implements both culling and level-of-detail techniques.

Algorithm A3
function renderNode(node, view, threshold)

| | |
|---|---|
| 1. | Let p be the primitive associated with a node |
| 2. | If p does not overlap with view, return |
| 3. | If a display size associated with p is |
| | above a predetermined threshold: |
| | a. For each child of the node, execute |
| | renderNode(child, view, threshold) |
| 4. | Else: |
| | a. Display p |

Step A3.2 of Algorithm A3 implements a culling technique by bypassing the display of any primitives that do not overlap with the user's view. The threshold argument in step A3.3 may provide a balance between rendering more detail vs achieving a higher frame rate. Essentially, if a particular primitive occupies a sufficiently large enough portion of the user's screen, e.g., the user has zoomed in on the primitive, then step A3.3 directs display module 250 to recursively apply Algorithm A3 to each of the primitive's children. Various embodiments of display module 250 may, for example, calculate the display size in step A3.3 using the size of a bounding box associated with the primitive, or the area of the primitive itself. If a display size associated with a child primitive is above the predetermined threshold, display module 250 may recursively apply Algorithm to each of the child's children.

In step A3.4.a, various embodiments may embellish the polygons with text labels that convey the associated entity's name and/or attributes, or render the primitive with stylized appearances, such as color schemes, gradient fills, or stylized outlines. The appearance of the primitive may also depend on whether the primitive corresponds to a leaf node or an internal node, or on a recursion depth associated with the primitive. Primitive rendering techniques may also include or enable reactive effects, such as highlighting a primitive and/or popping up a dialog window when a mouse or touch gesture is applied to the primitive.

Various embodiments in which an instance of hierarchical representation 240 may not fit into available memory may include variants of algorithm A3 that attempt to address the memory restriction. For a particular zoom level, display module 250 may pre-render a set of Voronoi treemap primitives into a set of tiles, where each tile is represented as a bitmap. Tiles are recursively subdivided into multiple tiles to account for the increase in detail as the user zooms in. A view is then rendered by dynamically loading the subset of tiles that overlap with the view at a particular zoom level, while falling back to previously rendered tiles if some are still being loaded.

Alternatively or additionally, various embodiments may partition hierarchical representation 240 into blocks, where each block contains a partial hierarchy. Display module 250 may render a view by dynamically loading the subset of blocks that overlap with the view, while falling back to previously rendered blocks if some are still being loaded. This approach may be suitable for embodiments that use a pre-computed Voronoi treemap, such that each node already contains a Voronoi polygon, or for embodiments where display module 250 computes the Voronoi treemap on-the-fly as the user navigates the map.

A block partitioning scheme may determine a required number of blocks and how to distribute hierarchy nodes across the blocks. For instance, a block partitioning scheme may allocate blocks on a hierarchy-level basis, such that the first block contains the top of the hierarchy including the root, the second block contains a range of levels directly below that, and additional blocks may contain additional lower levels. In various embodiments, a block partitioning scheme may operate on both a level basis and a spatial basis. Accordingly, each block may contain one or more sub-hierarchies across a range of levels. All nodes in the hierarchy represent a spatial location, and the children of a node are always close to their parent node by design of the clustering algorithm. Therefore, any sub-hierarchy, or a set of sub-hierarchies sharing ancestors, represents a spatial extent within the domain of the map. This scheme allows for loading a much smaller subset of nodes needed to render subsequent levels of detail during zooming.

In various embodiments, block partitioning schemes may require a referencing mechanism to determine which blocks to load next, either when zooming in or zooming out. Nodes associated with a block may reference child and/or parent nodes that may be located inside or outside of the same block. The latter requires resolving such child or parent references to a block id, which may be implemented using, for instance, a lookup table that maps each node id to a block id. In some embodiments, the node ids may be constructed such that they are contiguous within a block, which may reduce the lookup to a simpler mapping of a node id range to a block id. The lookup table itself may be downloaded as a separate block of data beforehand, or only those lookup entries relevant to a particular block may be appended to said block's hierarchy data. Additionally, block partitioning schemes may enforce a fixed node count in each block to promote the goal of keeping the block loading time constant.

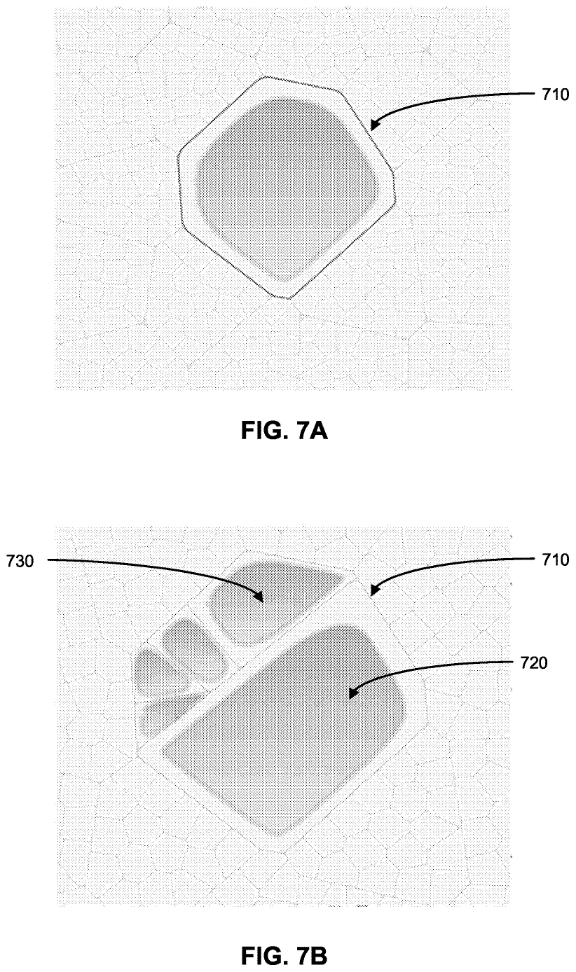

FIGS. 7A and 7B respectively illustrate sample graphical user interface displays of a Voronoi map depiction at first and second magnifications, according to some embodiments.

As shown, each of FIGS. 7A and 7B represents a view that is centered on primitive 710 that is included in a Voronoi map. FIG. 7A depicts a magnification or zoom level that is relatively lower than the magnification or zoom level associated with the view depicted in FIG. 7B. Accordingly, the depiction of primitive 710 in FIG. 7B occupies a larger portion of the user's view than the depiction of primitive 710 in FIG. 7A.

As discussed above in the description of display module 250, display module 250 may include a level-of-detail technique that is designed to balance an amount of detail presented to a user with an amount of computing resources necessary to maintain an acceptable display frame rate. As shown in FIG. 7B, the level-of-detail technique has determined that based on the user's selected magnification or zoom level, primitive 710 now occupies a sufficiently large enough portion of the user's view for display module 250 to be able to display additional detail within primitive 710 without unacceptably reducing the display frame rate. Accordingly, display module 250 directs the display of the smaller primitives, including primitives 720 and 730, that comprise primitive 710 but were previously inhibited from display.

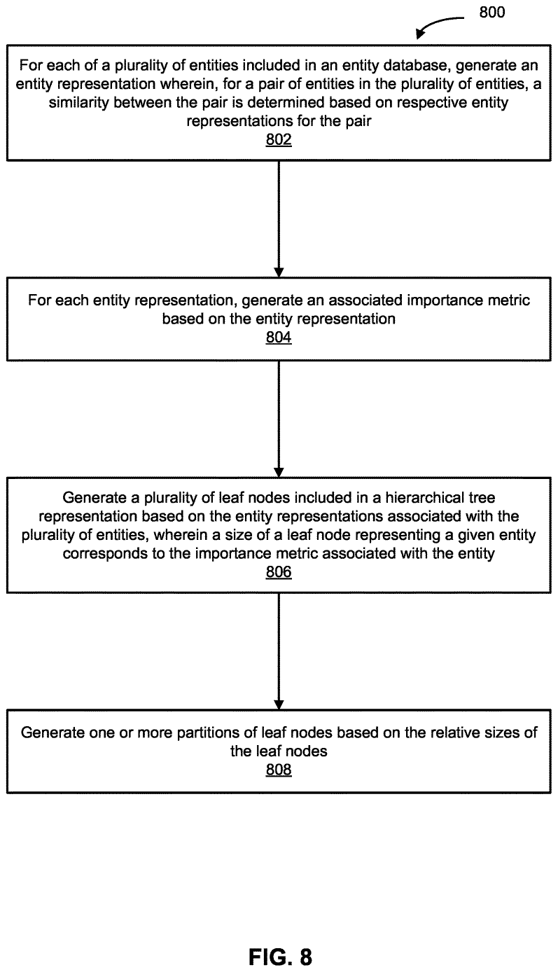

FIG. 8 is a flow diagram of method steps for generating one or more partitions including leaf nodes that each represent a different entity, according to some embodiments. Although the method steps are described in conjunction with the systems of FIGS. 1-2, persons skilled in the art will understand that any system configured to perform the method steps in any order falls within the scope of the present disclosure.

As shown, in step 802 of method 800, clustering module 230 of visualization engine 122 generates a leaf node associated with each of a plurality of entities included in entity database 200. For any pair of entities included in entity database 200, similarity analysis module 210 of visualization engine 122 determines a similarity between the pair based on the respective entity representations for the pair.

In various embodiments, similarity analysis module 210 of visualization engine 122 may analyze one or more attribute values associated with each of multiple entities included in entity database 200. Based on the one or more attribute values, similarity analysis module 210 may generate a high-dimensionality point associated with each entity representing a position in high-dimensionality space. Similarity analysis module 210 may generate a similarity score for each possible pairing of entities based on, e.g., a Euclidean distance between the positions associated with the pair. Similarity analysis module 210 may generate distance data 220, where distance data 220 may include a list of positions associated with the multiple entries and/or a distance matrix that includes pre-calculated distance values associated with each possible pairing of entities.

In step 804, visualization engine 122 may generate an importance metric for each of the multiple entities, where the importance metric is based on the entity representation. For example, visualization engine 122 may generate an importance metric associated with an entity based on one or more of the entity's attributes, such as the entity's headcount, market capitalization, geographical expanse, revenue, or profits.

In step 806, clustering module 230 generates a leaf node associated with each of the plurality of entities. Initially, clustering module 230 generates an ordered arrangement of the entities' leaf nodes based on the sizes associated with the leaf nodes, where a size associated with a leaf node corresponds to the importance metric associated with an entity represented by the leaf node.

In step 808, clustering module 230 generates one or more partitions of leaf nodes based on the relative sizes of the leaf nodes. In various embodiments, clustering module 230 may pre-initialize a set of partitions, where each partition includes an associated range of node size values. Clustering module 230 may then place each leaf node into a partition that includes a range of node size values that encompasses a size associated with the leaf node. In some embodiments, each partition included in the set of partitions may include the same width, i.e., the same associated ranges of node size values. In other embodiments, node size ranges associated with partitions may be based on a lower bound node size value, such that partitions associated with larger node size values may also include wider associated ranges of node size values.

In various embodiments, clustering module 230 may arrange the leaf nodes in an ordered list, generate a single partition, and move a quantity of leaf nodes from the ordered list into the single partition, where the quantity is based on a range criterion. Because leaf nodes are placed into partitions based on the leaf nodes' sizes, all of the leaf nodes included in a particular partition may include similar node sizes and may therefore be suitable for subsequent clustering to form internal nodes.

In sum, the disclosed techniques construct and visualize hierarchical entity relationships, including analyzing and visualizing hierarchical relationships between business-related entities. The disclosed techniques are operable to determine a level of similarity between two entities based on one or more attribute values associated with each of the entities. The techniques are also operable to calculate an importance metric value associated with an entity based on, e.g., entity attributes such as headcount, profit, or market capitalization.

Based on the entities and their associated attributes, the techniques may calculate and store similarity values for every possible pairing of entities. The techniques may generate leaf nodes associated with each of the entities and calculate a node size value for each of the leaf nodes based on the importance metric associated with the entity associated with the leaf node. A hierarchical representation of the multiple entities initially includes a one-dimensional arrangement of leaf nodes, ordered from smallest to largest based on the entities' size values. The techniques cluster similar nodes and similar clusters of nodes together to generate a hierarchical representation of entity relationships, where leaf nodes and/or internal nodes that appear on a same hierarchical level in the representation include similar node sizes, and clusters comprise multiple nodes and/or clusters representing similar entities and/or groups of entities. The techniques render the hierarchical representation for display to a user as, e.g., a tree structure or a Voronoi map.

In operation, a visualization engine constructs and visualizes hierarchical entity relationships, including analyzing and visualizing hierarchical relationships between business-related entities. A similarity analysis module included in the visualization engine may determine a level of similarity between two entities based on one or more attribute values associated with each of the entities. The visualization engine is also operable to calculate an importance metric value associated with an entity based on, e.g., entity attributes such as headcount, profit, or market capitalization.

Based on the entities and their associated attributes, the similarity analysis module may calculate and store similarity values for every possible pairing of entities. Each entity is associated with a position in high-dimensional space based on one or more entity attributes, and a measure of similarity between two entities may be based on a distance between the positions associated with the entities. The similarity analysis engine may store similarity data as a list of the positions associated with the entities, or as a distance matrix that includes pre-computed similarity values for every possible pairing of entities.

A clustering module included in the visualization engine may generate leaf nodes associated with each of the entities and calculate a node size value for each of the leaf nodes, where a node size value may be based on the importance metric associated with the entity corresponding to the leaf node. A hierarchical representation of the multiple entities initially includes a one-dimensional arrangement of leaf nodes, ordered from smallest to largest based on the entities' size values. The clustering module places each leaf node into a partition that includes a node size range that encompasses the leaf node's size. The clustering module processes the partitions from the partition that includes the smallest leaf nodes to the partition that includes the largest leaf nodes. From each partition, the clustering module identifies a group of leaf nodes suitable for clustering together to generate internal nodes, based on pairwise similarity values for the leaf nodes included in the partition. After all the partitions have been processed, the nodes (leaf nodes and internal nodes) are arranged in a hierarchical representation of entity relationships, where leaf nodes and/or internal nodes that appear on a same hierarchical level include similar node sizes, and groups of nodes associated with entities and/or groups of entities that are similar to one another are merged together into internal nodes. The clustering module generates a hierarchical representation of the entities, and a display module renders the representation for display to a user as, e.g., a tree structure or a Voronoi map.

One technical advantage of the disclosed techniques relative to the prior art is that the disclosed techniques process nodes on a per-partition basis by increasing size. These techniques ensure that smaller nodes are always clustered together before larger nodes, preserving the possibility that a cluster of smaller nodes may subsequently be merged with a larger node or cluster of nodes having a similar size as the cluster of smaller nodes. During visualization, sibling nodes (either leaf nodes, or internal nodes representing clusters of leaf nodes or clusters of clusters) occupying the same level of a tree map or similar hierarchical representation will always exhibit similar sizes, improving the readability and interpretability of the hierarchical representation. These technical advantages provide one or more improvements over prior art approaches.
Clause 1. A computer-implemented method for analyzing business-related entities, the computer-implemented method comprising: generating an entity representation associated with each of a plurality of entities wherein, for a pair of entities in the plurality of entities, a similarity between the pair is determined based on respective entity representations for the pair; generating, for each entity representation, an importance metric based on the entity representation; generating a plurality of leaf nodes included in a hierarchical tree representation based on the entity representations associated with the plurality of entities, wherein a size associated with a leaf node representing a given entity corresponds to the importance metric associated with the entity; and generating two or more partitions of leaf nodes based on the sizes associated with each of the leaf nodes.
Clause 2. The computer-implemented method of clause 1, wherein the similarity between the pair of entities is determined based on vector space locations associated with each entity included in the pair of entities.
Clause 3. The computer-implemented method of any of clauses 1-2, wherein each of the two or more partitions includes an associated range of node size values, and a leaf node included in the plurality of leaf nodes is placed into one of the two or more partitions based on the size of the leaf node and the range of node size values associated with the one of the two or more partitions.
Clause 4. The computer-implemented method of any of clauses 1-3, wherein the ranges of node size values associated with each of the two or more partitions are identical.
Clause 5. The computer-implemented method of any of clauses 1-4, wherein the range of node size values associated with the one of the two or more partitions is proportional to a minimum node size value associated with the one of the two or more partitions.
Clause 6. The computer-implemented method of any of clauses 1-5, further comprising: processing, during one or more iterations, a first partition included in the two or more partitions to identify a group of at least two nodes included in the first partition, wherein the group of nodes contains either or both of leaf or internal nodes; merging the identified group of nodes to generate a new internal node; aggregating sizes of the nodes in the identified group to determine an aggregated size associated with the new internal node, wherein the aggregated size is greater than a size associated with each node in the identified group; placing the new internal node into the first partition or into a second partition included in the two or more partitions; determining that the first partition includes fewer than two nodes; and terminating the processing of the first partition based at least on the determination.
Clause 7. The computer-implemented method of any of clauses 1-6, wherein the processing is performed in an ascending partition order, such that the first partition includes relatively smaller leaf or internal nodes than the second partition, and the second partition is processed after the first partition.
Clause 8. The computer-implemented method of any of clauses 1-7, further comprising recording a hierarchical relationship between the new internal node and each node included in the identified group of nodes.
Clause 9. The computer-implemented method of any of clauses 1-8, further comprising generating a hierarchical representation of entity relationships, wherein the hierarchical representation includes a root node and one or more internal nodes or leaf nodes.
Clause 10. The computer-implemented method of any of clauses 1-9, wherein multiple internal or leaf nodes located at a same level in the hierarchical representation include similar associated node sizes.
Clause 11. One or more non-transitory, computer-readable media containing instructions that, when executed by one or more processors, cause the one or more processors to perform the steps of: generating an entity representation associated with each of a plurality of entities wherein, for a pair of entities in the plurality of entities, a similarity between the pair is determined based on respective entity representations for the pair; generating, for each entity representation, an importance metric based on the entity representation; generating a plurality of leaf nodes included in a hierarchical tree representation based on the entity representations associated with the plurality of entities, wherein a size associated with a leaf node representing a given entity corresponds to the importance metric associated with the entity; and generating two or more partitions of leaf nodes based on the sizes associated with each of the leaf nodes.
Clause 12. The one or more non-transitory, computer-readable media of clause 11, wherein each of the two or more partitions includes an associated range of node size values, and a leaf node included in the plurality of leaf nodes is placed into one of the two or more partitions based on the size of the leaf node and the ranges of node size values associated with each of the two or more partitions.
Clause 13. The one or more non-transitory, computer-readable media of any of clauses 11-12, wherein the range of node size values associated with one of the two or more partitions is proportional to a minimum node size value associated with the one of the two or more partitions.
Clause 14. The one or more non-transitory, computer-readable media of any of clauses 11-13, further comprising: processing, during one or more iterations, a first partition included in the two or more partitions to identify a group of at least two nodes included in the first partition, wherein the group of nodes contains either or both of leaf or internal nodes; merging the identified group of nodes to generate a new internal node; aggregating sizes of the nodes in the identified group to determine an aggregated size associated with the new internal node, wherein the aggregated size is greater than a size associated with each node in the identified group; placing the new internal node into the first partition or into a second partition included in the two or more partitions; determining that the first partition includes fewer than two nodes; and terminating the processing of the first partition based at least on the determination.
Clause 15. The one or more non-transitory, computer-readable media of any of clauses 11-14, wherein the processing is performed in an ascending partition order, such that the first partition includes relatively smaller leaf or internal nodes than the second partition, and the second partition is processed after the first partition.
Clause 16. The one or more non-transitory, computer-readable media of any of clauses 11-15, further comprising recording a hierarchical relationship between the new internal node and each node included in the identified group of nodes.
Clause 17. The one or more non-transitory, computer-readable media of any of clauses 11-16, wherein multiple internal or leaf nodes located at a same level in a hierarchical representation of entity relationships include similar associated node sizes, and internal nodes included in the hierarchical representation comprise multiple similar nodes.
Clause 18. A system comprising: one or more memories storing instructions; and one or more processors for executing the instructions to: generate an entity representation associated with each of a plurality of entities wherein, for a pair of entities in the plurality of entities, a similarity between the pair is determined based on respective entity representations for the pair; generate, for each entity representation, an importance metric based on the entity representation; generate a plurality of leaf nodes included in a hierarchical tree representation based on the entity representations associated with the plurality of entities, wherein a size associated with a leaf node representing a given entity corresponds to the importance metric associated with the entity; and generate two or more partitions of leaf nodes based on the sizes associated with each of the leaf nodes.
Clause 19. The system of clause 18, wherein the one or more processors further execute the instructions to: process, during one or more iterations, a first partition included in the two or more partitions to identify a group of at least two nodes included in the first partition, wherein the group of nodes contains either or both of leaf or internal nodes; merge the identified group of nodes to generate a new internal node; aggregate sizes of the nodes in the identified group to determine an aggregated size associated with the new internal node, wherein the aggregated size is greater than a size associated with each node in the identified group; place the new internal node into the first partition or into a second partition included in the two or more partitions; determine that the first partition includes fewer than two nodes; and terminate the processing of the first partition based at least on the determination.
Clause 20. The system of any of clauses 18-19, wherein each of the two or more partitions includes an associated range of node size values, and a leaf node included in the plurality of leaf nodes is placed into one of the two or more partitions based on the size of the leaf node and the range of node size values associated with the one of the two or more partitions.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that may contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for analyzing business-related entities, the computer-implemented method comprising:
generating an entity representation associated with each of a plurality of entities wherein, for a pair of entities in the plurality of entities, a similarity between the pair is determined based on respective entity representations for the pair;
generating, for each entity representation, an importance metric based on the entity representation;
generating a plurality of leaf nodes included in a hierarchical tree representation based on the entity representations associated with the plurality of entities, wherein a size associated with a leaf node representing a given entity corresponds to the importance metric associated with the entity; and
generating two or more partitions of leaf nodes based on the sizes associated with each of the leaf nodes.

2. The computer-implemented method of claim 1, wherein the similarity between the pair of entities is determined based on vector space locations associated with each entity included in the pair of entities.

3. The computer-implemented method of claim 1, wherein each of the two or more partitions includes an associated range of node size values, and a leaf node included in the plurality of leaf nodes is placed into one of the two or more partitions based on the size of the leaf node and the range of node size values associated with the one of the two or more partitions.

4. The computer-implemented method of claim 3, wherein the ranges of node size values associated with each of the two or more partitions are identical.

5. The computer-implemented method of claim 3, wherein the range of node size values associated with the one of the two or more partitions is proportional to a minimum node size value associated with the one of the two or more partitions.

6. The computer-implemented method of claim 1, further comprising:
processing, during one or more iterations, a first partition included in the two or more partitions to identify a group of at least two nodes included in the first partition, wherein the group of nodes contains either or both of leaf or internal nodes;
merging the identified group of nodes to generate a new internal node;
aggregating sizes of the nodes in the identified group to determine an aggregated size associated with the new internal node, wherein the aggregated size is greater than a size associated with each node in the identified group;
placing the new internal node into the first partition or into a second partition included in the two or more partitions;
determining that the first partition includes fewer than two nodes; and
terminating the processing of the first partition based at least on the determination.

7. The computer-implemented method of claim 6, wherein the processing is performed in an ascending partition order, such that the first partition includes relatively smaller leaf or internal nodes than the second partition, and the second partition is processed after the first partition.

8. The computer-implemented method of claim 6, further comprising recording a hierarchical relationship between the new internal node and each node included in the identified group of nodes.

9. The computer-implemented method of claim 1, further comprising generating a hierarchical representation of entity relationships, wherein the hierarchical representation includes a root node and one or more internal nodes or leaf nodes.

10. The computer-implemented method of claim 8, wherein multiple internal or leaf nodes located at a same level in the hierarchical representation include similar associated node sizes.

11. One or more non-transitory, computer-readable media containing instructions that, when executed by one or more processors, cause the one or more processors to perform the steps of:
generating an entity representation associated with each of a plurality of entities wherein, for a pair of entities in the plurality of entities, a similarity between the pair is determined based on respective entity representations for the pair;
generating, for each entity representation, an importance metric based on the entity representation;
generating a plurality of leaf nodes included in a hierarchical tree representation based on the entity representations associated with the plurality of entities, wherein a size associated with a leaf node representing a given entity corresponds to the importance metric associated with the entity; and
generating two or more partitions of leaf nodes based on the sizes associated with each of the leaf nodes.

12. The one or more non-transitory, computer-readable media of claim 11, wherein each of the two or more partitions includes an associated range of node size values, and a leaf node included in the plurality of leaf nodes is placed into one of the two or more partitions based on the size of the leaf node and the ranges of node size values associated with each of the two or more partitions.

13. The one or more non-transitory, computer-readable media of claim 12, wherein the range of node size values associated with one of the two or more partitions is proportional to a minimum node size value associated with the one of the two or more partitions.

14. The one or more non-transitory, computer-readable media of claim 11, further comprising:
processing, during one or more iterations, a first partition included in the two or more partitions to identify a group of at least two nodes included in the first partition, wherein the group of nodes contains either or both of leaf or internal nodes;
merging the identified group of nodes to generate a new internal node;
aggregating sizes of the nodes in the identified group to determine an aggregated size associated with the new internal node, wherein the aggregated size is greater than a size associated with each node in the identified group;
placing the new internal node into the first partition or into a second partition included in the two or more partitions;
determining that the first partition includes fewer than two nodes; and
terminating the processing of the first partition based at least on the determination.

15. The one or more non-transitory, computer-readable media of claim 14, wherein the processing is performed in an ascending partition order, such that the first partition includes relatively smaller leaf or internal nodes than the second partition, and the second partition is processed after the first partition.

16. The one or more non-transitory, computer-readable media of claim 14, further comprising recording a hierarchical relationship between the new internal node and each node included in the identified group of nodes.

17. The one or more non-transitory, computer-readable media of claim 14, wherein multiple internal or leaf nodes located at a same level in a hierarchical representation of entity relationships include similar associated node sizes, and internal nodes included in the hierarchical representation comprise multiple similar nodes.

18. A system comprising:
one or more memories storing instructions; and
one or more processors for executing the instructions to:
generate an entity representation associated with each of a plurality of entities wherein, for a pair of entities in the plurality of entities, a similarity between the pair is determined based on respective entity representations for the pair;
generate, for each entity representation, an importance metric based on the entity representation;
generate a plurality of leaf nodes included in a hierarchical tree representation based on the entity representations associated with the plurality of entities, wherein a size associated with a leaf node representing a given entity corresponds to the importance metric associated with the entity; and
generate two or more partitions of leaf nodes based on the sizes associated with each of the leaf nodes.

19. The system of claim 18, wherein the one or more processors further execute the instructions to:
process, during one or more iterations, a first partition included in the two or more partitions to identify a group of at least two nodes included in the first partition, wherein the group of nodes contains either or both of leaf or internal nodes;
merge the identified group of nodes to generate a new internal node;
aggregate sizes of the nodes in the identified group to determine an aggregated size associated with the new internal node, wherein the aggregated size is greater than a size associated with each node in the identified group;
place the new internal node into the first partition or into a second partition included in the two or more partitions;
determine that the first partition includes fewer than two nodes; and
terminate the processing of the first partition based at least on the determination.

20. The system of claim 18, wherein each of the two or more partitions includes an associated range of node size values, and a leaf node included in the plurality of leaf nodes is placed into one of the two or more partitions based on the size of the leaf node and the range of node size values associated with the one of the two or more partitions.
